(19) United States
(12) Patent Application Publication
(10) Pub. No.: US 2011/0078610 A1
(43) Pub. Date: Mar. 31, 2011

(54) INFORMATION PROCESSING SYSTEM, INFORMATION PROCESSING METHOD, AND COMPUTER READABLE MEDIUM

(75) Inventor: KIYOSHI TASHIRO, Kawasaki-shi (JP)

(73) Assignee: FUJI XEROX CO., LTD., Tokyo (JP)

(21) Appl. No.: 12/955,801

(22) Filed: Nov. 29, 2010

Related U.S. Application Data
(63) Continuation of application No. 11/876,324, filed on Oct. 22, 2007.

(30) Foreign Application Priority Data
Mar. 30, 2007 (JP) 2007-092766

(51) Int. Cl. G06F 9/318; G06F 3/048

(52) U.S. Cl. 715/771; 712/226; 712/E09.035

(57) ABSTRACT

An information processing system includes: a division instruction receiving unit that receives a first instruction which instructs division processing to an object; a division processing execution unit that executes the division processing to the object according to the first instruction to generate a plurality of objects; a memory that stores state information of the object and the plurality of objects; a restoration instruction receiving unit that receives designation of at least one of the plurality of objects and a second instruction which instructs restoration processing of the object; and a restoration processing execution unit that executes the restoration processing of the object on the basis of the state information, according to the second instruction.

### CROSS-REFERENCE TO RELATED APPLICATION

This is a continuation application of application Ser. No. 11/876,324, the entire disclosure of which is incorporated herein by reference. Further, this application is based on and claims priority under 35 USC §119 from Japanese Patent Application No. 2007-92766 filed Mar. 30, 2007.

### BACKGROUND

(i) Technical Field

The present invention relates to an information processing system, an information processing method, and a computer readable medium for information processing.

(ii) Related Art

A function referred to as a ‘recycle bin’, an ‘Undo’ function (function of canceling processing executed immediately before and causing to return to a state before executing the processing), a data backup method/device, and the like have been proposed to restore data deleted due to an erroneous operation on a PC (personal computer) or data before an editing operation on the PC.

### SUMMARY

According to an aspect of the invention, there is provided an information processing system comprising:

a division instruction receiving unit that receives a first instruction which instructs division processing to an object;

a division processing execution unit that executes the division processing to the object according to the first instruction to generate a plurality of objects;

a memory that stores state information of the object and the plurality of objects;

a restoration instruction receiving unit that receives designation of at least one of the plurality of objects and a second instruction which instructs restoration processing of the object; and
a restoration processing execution unit that executes the restoration processing of the object on the basis of the state information, according to the second instruction.

### BRIEF DESCRIPTION OF THE DRAWINGS

Embodiments of the present invention will be described in detail based on the following figures, wherein:

FIG. 1 is a view illustrating a conceptual module configuration according to an exemplary embodiment of the invention;

FIG. 2 is a flow chart illustrating an example of division processing or combination processing;

FIG. 3 is a flow chart illustrating an example of restoration processing;

FIG. 4 is a view schematically illustrating the relationship between editing software and a storage module and embodiments of structures of the editing software and the storage module;

FIG. 5 is a view schematically illustrating an concrete example of the embodiment;

FIG. 6 is an explanatory view illustrating an example of the data structure in a storage module;

FIG. 7 is an explanatory view illustrating an example of the data structure in a storage module;

FIG. 8 is an explanatory view illustrating an example of a user interface for restoration processing;

FIG. 9 is an explanatory view illustrating an example of a user interface for restoration processing; and

FIG. 10 is a view illustrating a hardware configuration of a computer for realizing the embodiment,

wherein reference numerals and signs in the drawings has the meanings as set forth below.
11: division/combination instruction receiving module
12: division/combination processing execution module
13: storage module (memory)
14: restoration instruction receiving module
15: identification module
16: restoration processing execution module
40: editing APL
51A, 51B, 51C: PC
52: document database
53: network
60: history table
401: editing module
402: restoration module
1001: CPU
1002: RAM
1003: ROM
1004: HD
1005: output device
1006: input device
1007: communication line interface
1008: bus

### DETAILED DESCRIPTION

Hereinafter, an exemplary embodiment that is suitable for realizing the invention will be described with reference to the accompanying drawings.

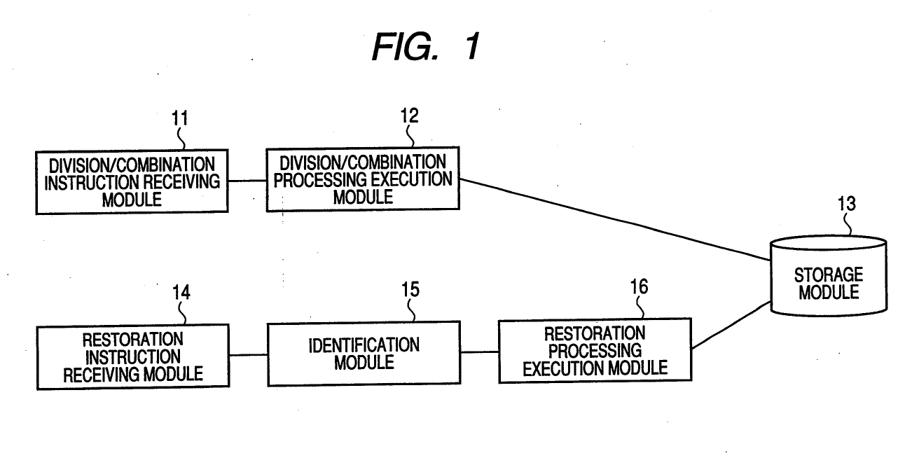

FIG. 1 is a view illustrating the conceptual module configuration in the present embodiment. In addition, modules generally refer to logically separable components, such as software and hardware. Therefore, a module in the present embodiment indicates not only a module in a program but also a module in the hardware configuration. Thus, in the present embodiment, a method is also described in addition to a program and a system. Moreover, a module corresponds to a function in almost one-to-one manner. However, at the time of mounting, one module may be realized using one program or a plurality of modules may be realized using one program. Alternatively, one module may be realized using a plurality of programs. In addition, a plurality of modules may be executed by one computer, or one module may be executed by a plurality of computers in a distribution or parallel environment. In addition, other modules may be included in one module. In addition, ‘connection’ referred hereinafter includes logical connection (transmission and reception of data, instruction, and so on) as well as physical connection.

Further, a system or an apparatus may be realized by connecting a plurality of computers, hardware, and apparatuses to one another using a communication unit such as a network or may be realized using a computer, hardware, and an apparatus.

An ‘object’ refers to a group of electronic information that can be processed by a computer. Specifically, the object includes an electronic document (hereinafter, simply referred to as a ‘document’), image data, sound data, video data (sound data may be included), a database, and the like.

Hereinafter, an object will be described using a document as a main example. In addition, documents include a document that is processed using a so-called word processor (document software), a paragraph that is a constituent element of the document, a file, and the like.

In addition, processing for dividing a document (i.e., division processing to a document) is processing for creating independent documents from a document configured to include a plurality of constituent elements by using each of the constituent elements (each of the constituent elements may also include a plurality of constituent elements) as a unit, for example. More specifically, the processing includes processing for dividing a document having a plurality of pages into documents each having a unit page, processing for dividing a document having a plurality of pages into two documents, and the like.

In addition, processing for combining documents is processing for putting together (for example, synthesis, integration, and combination) a plurality of documents into one document. More specifically, there are processing for adding a document behind another document, processing for combining two documents such that pages of the two documents are alternately bound, and so on.

In addition, the document division processing or the document combination processing may include processing performed according to the division processing or the combination processing, for example, page number allocation processing.

The present embodiment relates to a system for editing a document. As shown in FIG. 1, the system includes a division/combination instruction receiving module 11, a division/combination processing execution module 12, a storage module 13, a restoration instruction receiving module 14, an identification module 15, and a restoration processing execution module 16.

As shown in FIG. 1, the division/combination processing execution module 12 is connected with the division/combination instruction receiving module 11 and receives a document division or combination instruction. The instruction may be performed on the basis of a user's operation on a document or may be automatically executed by a program or the like. When the instruction is received, the division/combination instruction receiving module 11 causes the division/combination processing execution module 12 to execute corresponding processing.

As shown in FIG. 1, the division/combination processing execution module 12 is connected with the division/combination instruction receiving module 11 and the storage module 13. The division/combination processing execution module 12 executes processing for dividing or combining target documents on the basis of an execution instruction from the division/combination instruction receiving module 11 and stores a state before executing the processing, a history, and the like in the storage module 13.

As shown in FIG. 1, the storage module 13 is accessed from the division/combination processing execution module 12 and the restoration processing execution module 16 and stores a state before executing document division or combination processing, a history, and the like.

The restoration instruction receiving module 14 is connected with the identification module 15, as shown in FIG. 1, and receives an instruction of document restoration processing. In the same manner as the division/combination instruction receiving module 11, the instruction may be performed on the basis of a user's operation on a document or may be automatically executed by a program or the like. When the instruction is received, the restoration instruction receiving module 14 causes the identification module 15 to identify state information required for the restoration processing.

The identification module 15 is connected with the restoration instruction receiving module 14 and the restoration processing execution module 16, as shown in FIG. 1, and identifies state information regarding a plurality of documents after processing, which includes a document to be restored. The identification may be performed on the basis of a user's operation on a document obtained after the division processing or the combination processing or may be automatically executed by a program or the like. Alternatively, at the time of an instruction from the restoration instruction receiving module 14, the state information may be identified together with an instruction of restoration processing. When the identification is performed, the identification module 15 causes the restoration processing execution module 16 to execute restoration processing.

As shown in FIG. 1, the restoration processing execution module 16 is connected with the storage module 13 and the identification module 15. When the restoration instruction receiving module 14 receives a restoration processing instruction, the restoration processing execution module 16 executes document restoration processing on the basis of the state information identified by the identification module 15 and a state before the processing stored in the storage module 13. That is, the restoration processing execution module 16 searches the state before processing stored in the storage module 13 by using the state information and then executes the restoration processing. When executing the restoration processing, it may be possible to perform restoration of processing executed together with the division processing or the combination processing.

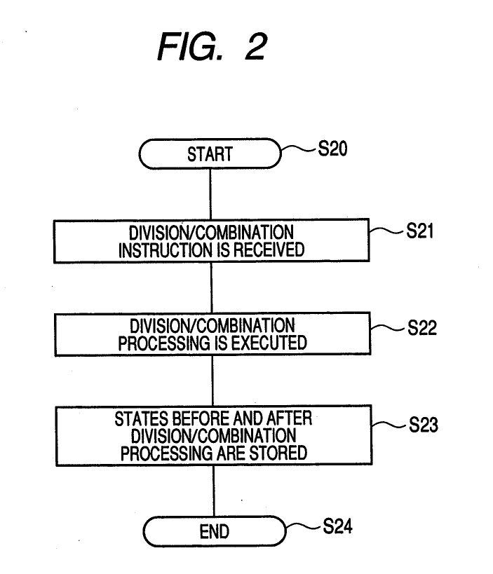

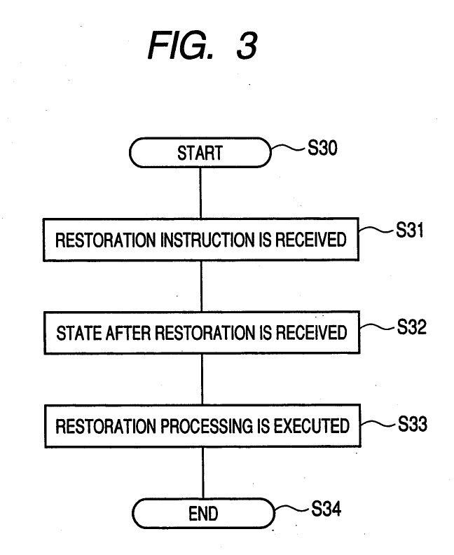

Next, an operation and a function (operation) will be described with reference to FIGS. 2 and 3.

An example of division processing or combination processing will be described using a flow chart shown in FIG. 2.

In step S21, the division/combination instruction receiving module 11 receives a division processing instruction or a combination processing instruction from an operator or the like.

In step S22, the division/combination processing execution module 12 executes document division processing or document combination processing on the basis of the instruction received in step S21.

In step S23, the division/combination processing execution module 12 stores a history of the processing in step S22 in the storage module 13. At this time, at least a state before executing the division processing or the combination processing is stored in the storage module 13. Other examples to be stored in the storage module 13 include date and time of processing instruction, an identifier of an operator, and the like.

An example of restoration processing will now be described using a flow chart shown in FIG. 3.

In step S31, the restoration instruction receiving module 14 receives a restoration processing instruction from an operator or the like.

In step S32, the identification module 15 identifies state information regarding a plurality of documents after processing, including a document to be restored.

In step S33, the restoration processing execution module 16 executes document restoration processing on the basis of the state information identified in step S32 and a state before the processing stored in step S23.

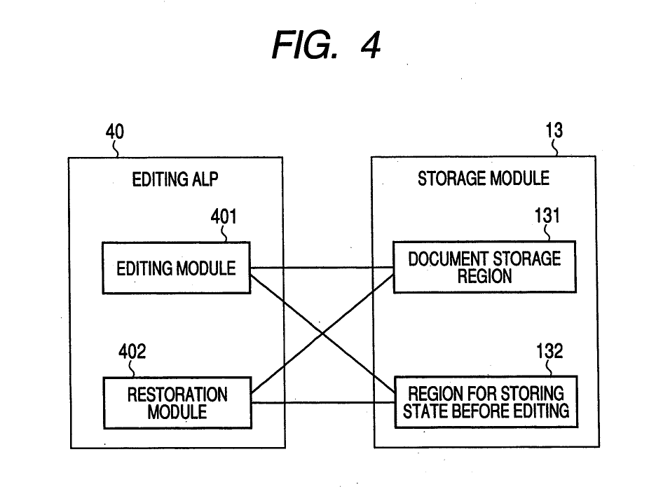

Next, the relationship between editing software and the storage module 13 and embodiments of structures of the editing software and the storage module 13 will be described with reference to FIG. 4.

Document division processing or document combination processing may be realized as one function of document editing application (editing APL 40). In this case, the division/combination instruction receiving module 11 and the division/combination processing execution module 12 are provided as an editing module 401, and the restoration instruction receiving module 14, the identification module 15, and the restoration processing execution module 16 are provided as a restoration module 402.

In addition, the storage module 13 includes a document storage region 131 and a region 132 for storing a state before editing.

The document storage region 131 mainly stores a document and is accessed from the editing module 401 and the restoration module 402. The editing module 401 mainly takes out a document to be edited or stores a document after editing. The restoration module 402 mainly takes out a document after editing that is to be restored.

The region 132 for storing a state before editing mainly stores processing history (a state before editing processing and the like are included) and is accessed from the editing module 401 and the restoration module 402. As a state before editing processing, a document before division processing or combination processing may be stored, the document before division processing or combination processing may be stored in a server or the like and the location where the document is stored may be stored, or only processing details including processing executed according to the division processing or the combination processing may be stored. The editing module 401 mainly stores an editing history. The restoration module 402 mainly takes out the editing history stored in the editing module 401.

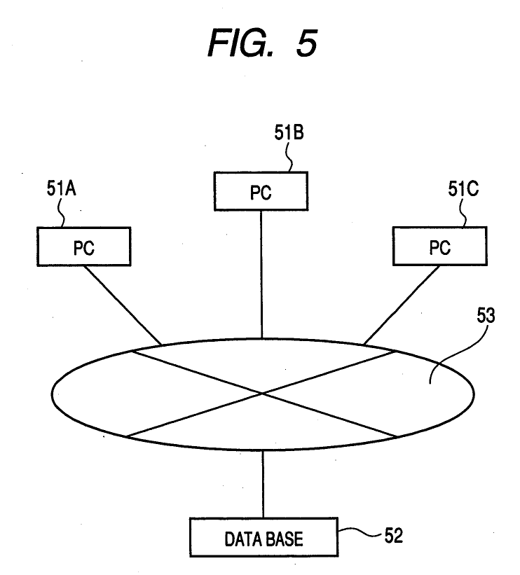

Next, an exemplary example of the present embodiment will be described with reference to FIG. 5.

The storage module 13 described with reference to FIG. 4 may be a specific region within a storage device, such as a hard disk, in a PC or may be a specific region of, for example, a server connected through a network or the like. For example, as shown in FIG. 5, the editing APL 40 is provided in a PC 51A (51B, 51C) and the storage module 13 is located in a document database 52 of a server that is connected to the PC 51A (51B, 51C) through a network 53 serving as a communication line. With the configuration described above, restoration processing may be executed for a document which has been subjected to the division processing or the combination processing by other PCs (operator).

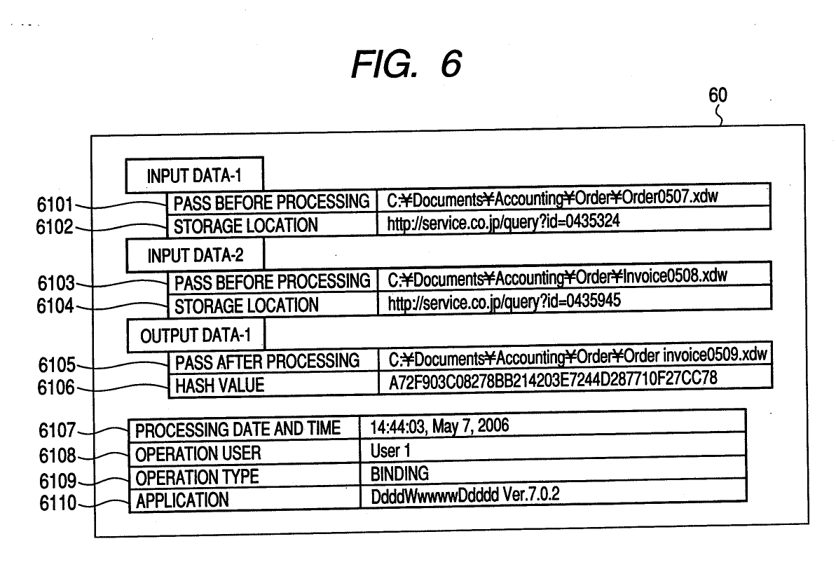

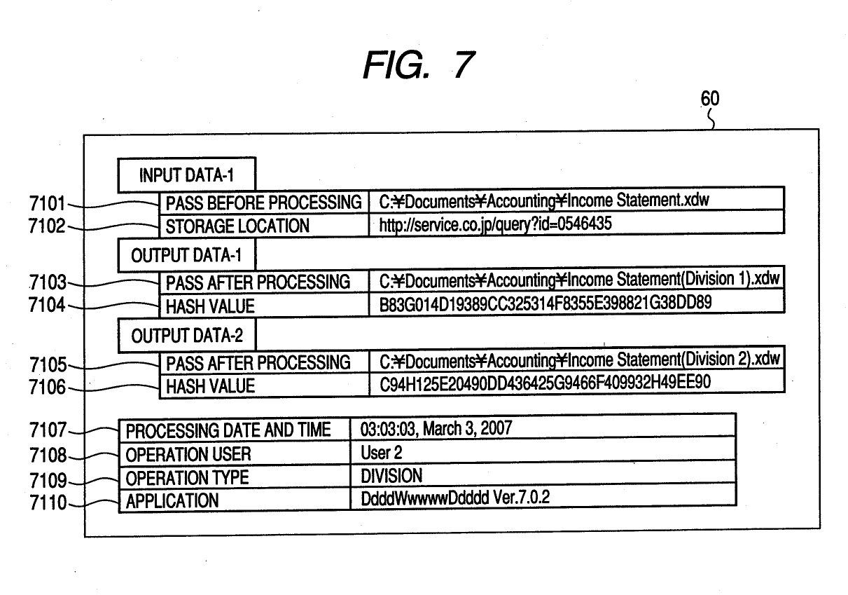

Next, an example of the structure of data within the storage module 13 will be described with reference to FIGS. 6 and 7. FIG. 6 shows an example of the structure of history data (a state before combination processing is included) related to document combination processing. Here, the history data is history data related to combination processing for combining two documents into one document.

A history table 60 includes a path column 6101 before processing, a storage location column 6102, a path column 6103 before processing, a storage location column 6104, a path column 6105 after processing, a hash value column 6106, and a processing date and time column 6107, an operation user column 6108, an operation type column 6109, and an application column 6110.

A first document before processing (document for which combination processing is to be executed) has the path column 6101 before processing and the storage location column 6102, a second document before processing (document for which combination processing is to be executed) has the path column 6103 before processing and the storage location column 6104, and a document after combination processing has the path column 6105 after processing and the hash value column 6106. Further, the processing date and time column 6107, the operation user column 6108, the operation type column 6109, and the application column 6110 are included as typical history information.

In the path columns 6101 and 6103 before processing, a path (for example, file location in an operating system (OS), query data used to take out corresponding data from a server, and a URI (uniform resource identifier)) of a document before combination processing is stored.

In the storage location columns 6102 and 6104, a path indicating a storage location of the document before combination processing is stored. That is, the division/combination processing execution module 12 creates a duplication of the document before executing the combination processing.

In the path column 6105 after processing, a path of a document after combination processing is stored.

In the hash value column 6106, a hash value for verifying the identity of contents of the document after combination processing is stored. Moreover, the division/combination processing execution module 12 creates a hash value using a one-way function, it is extremely difficult to create different data items having the same hash value.

Date and time when combination processing has been performed, an identifier of an operator, an operation type (‘binding’ is used as a function name of combination processing in FIG. 6), and an application name are stored in the processing date and time column 6107, the operation user column 6108, the operation type column 6109, and the application column 6110, respectively.

FIG. 7 shows an example of the structure of history data (a state before division processing is included) related to document division processing. Here, the history data is history data related to division processing for dividing one document into two documents.

A history table 60 includes a path column 7101 before processing, a storage location column 7102, a path column 7103 after processing, a hash value column 7104, a path column 7105 after processing, a hash value column 7106, and a processing date and time column 7107, an operation user column 7108, an operation type column 7109, and an application column 7110.

A target document before division processing has the path column 7101 before processing and the storage location column 7102, a first document after division processing has the path column 7103 after processing and the hash value column 7104, and a second document after division processing has the path column 7105 after processing and the hash value column 7106. In addition, the processing date and time column 7107, the operation user column 7108, the operation type column 7109, and the application column 7110 are included as typical history information.

In the path column 7101 before processing, a path of the document before division processing is stored.

In the storage location column 7102, a path indicating a storage location of the document before division processing is stored. That is, the division/combination processing execution module 12 creates a duplication of the document before executing the division processing.

In the path columns 7103 and 7105 after processing, a path of the document after division processing is stored.

In the hash value columns 7104 and 7106, a hash value for verifying the identity of contents of the document after division processing is stored.

Date and time when combination processing has been performed, an identifier of an operator, an operation type, and an application name are stored in the processing date and time column 7107, the operation user column 7108, the operation type column 7109, and the application column 7110, respectively.

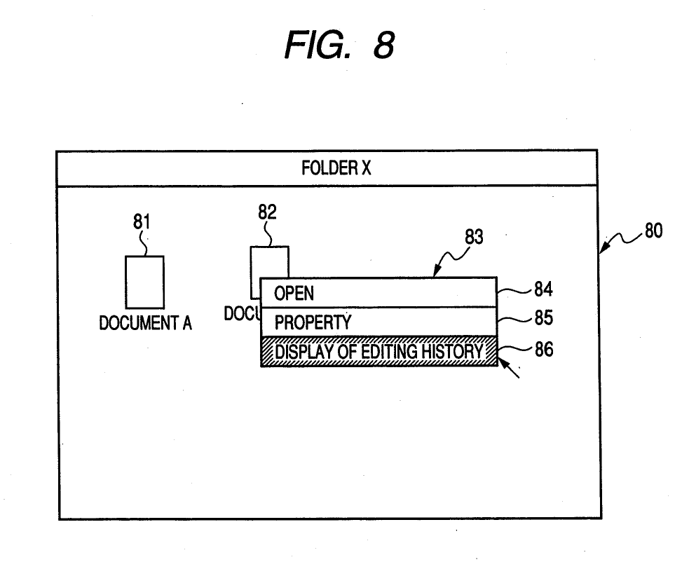

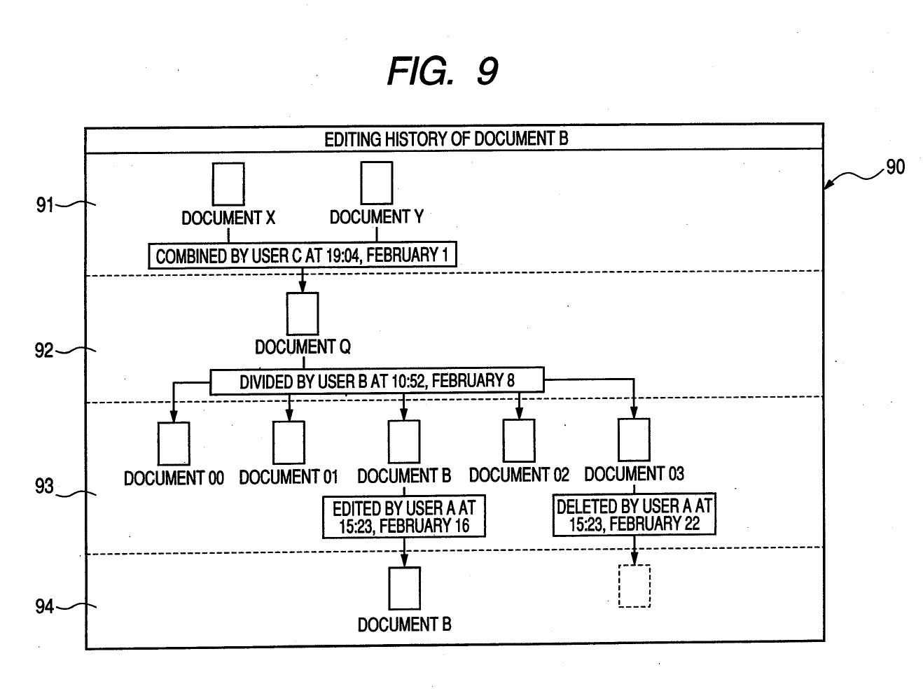

Next, an example of a user interface for restoration processing will be described with reference to FIGS. 8 and 9.

In FIG. 8, the editing APL 40 is displayed on a screen of a PC or the like. A document A81 and a document B82 within a folder X80 are displayed, and commands operable with respect to the document B82 are displayed using a menu 83 by means of an operator's operation (for example, an operation of pressing a right button of a mouse). A ‘display of editing history’ command 86 is included in the menu 83. If an operator instructs the ‘display of editing history’ command 86, an editing history display area 90 of the document B is displayed as shown in FIG. 9. That is, the restoration instruction receiving module 14 receives a restoration instruction, and the identification module 15 displays the editing history display area 90 of the document B in order to identify an object to be restored.

In an example shown in FIG. 9, state information on past editing history of the document B82 is visually displayed. The editing history display area 90 of the document B is separated to be displayed according to the past history. In addition, a document is displayed by an icon (figure indicating a document) or a thumbnail (image displayed by reducing an image when opening a document). By alternately disposing a document and an editing operation, a history is displayed in a time-sequential manner and in a hierarchical manner such that the layer structure of document editing can be understood

Specifically, as for a history regarding the document B82, (1) a user C generated a document Q by combining a document X and a document Y, (2) a user B divided the document Q into a document 00, a document 01, a document B, a document 02, and a document 03, (3) a user A edited the document B, and (4) the user A deleted the document 03.

A state before performing processing (1) and details of the processing (1) are displayed on a first hierarchical display region 91. A state before performing processing (2) and details of the processing (2) are displayed on a second hierarchical display region 92. A state before performing processing (3) and (4) and details of the processing (3) and (4) are displayed on a third hierarchical display region 93. A state after performing processing (3) and (4) is displayed on a fourth hierarchical display region 94.

In this case, for example, if an operator designates the document 01 and instructions restoration processing for the document 01, the restoration instruction receiving module 14 receives the instruction, the identification module 15 identifies the document 01 designated by the user's operation through the display within the editing history display area 90 of the document B, and the restoration processing execution module 16 restores the document Q in the storage module 13.

In the case when a document was deleted, the deleted document (result of processing (4)) may be displayed in a dotted line as shown in FIG. 9 and the document displayed in the dotted line may be identified to perform restoration processing.

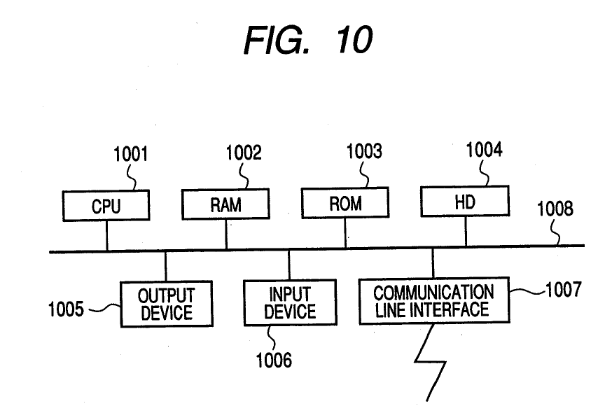

Furthermore, as shown in FIG. 10, the hardware configuration of a computer executed by a program according to the present embodiment is the same as that of a typical computer. Specifically, the computer executed by a program according to the present embodiment is a personal computer, a computer that can serve as a server, and the like. The hardware configuration may include: a CPU (microprocessor) 1001 that executes programs, such as the division/combination instruction receiving module 11, the division/combination processing execution module 12, the restoration instruction receiving module 14, the identification module 15, and the restoration processing execution module 16; a RAM (random access memory) 1002 that stores the programs and data; a ROM (read only memory) 1003 in which a program for booting the computer and the like are stored; a HD (hard disk) 1004 serving as an auxiliary storage device; an input device 1006 used to input data, such as a keyboard and a mouse; an output device 1005, such as a CRT and a liquid crystal display; a communication line interface 1007 used to perform communication with other apparatuses through, for example, a network; and a bus 1008 that enables data communication therebetween. A plurality of these computers may be connected to each other through a network.

The hardware configuration shown in FIG. 10 is only an example of the configuration. The present embodiment is not limited to the configuration shown in FIG. 10, but it may be possible to use the configuration in which the modules described in the present embodiment are executable. For example, some of the modules may be configured using dedicated hardware (for example, application specific integrated circuit (ASIC)). In addition, some of the modules may be provided in an external system connected through a communication line. Alternatively, a plurality of systems shown in FIG. 10 may be connected to one another through a communication line so as to perform a cooperative operation. In particular, in addition to the personal computer, the program according to the program may be included in a portable information terminal such as a personal digital assistant, an information appliance, a copying machine, a facsimile, a scanner, a printer, a composite machine (also referred to as a multi-functional copying machine and has functions of a scanner, a printer, a copying machine, a facsimile, and the like), and the like. In addition, the program according to the present embodiment may be included in other programs, such as a word processor.

In the embodiment described above, processing for restoring the division processing or the combination processing has been shown. However, processing for restoring the restoration processing may be executed. That is, since the combination processing that is restoration of the division processing and the division processing that is restoration of the combination processing are restored, the processing for restoring the restoration processing may be realized with the same configuration.

Further, in the embodiment described above, data before processing and operation records on a plurality of PCs are collectively stored in a server or the like, such that processing executed by a plurality of operators has been restored by showing the relationship between the processing and documents. However, whether or not to allow a document, which is edited by a predetermined operator, to be restored by another operator may be selected. In order to do so, documents before processing are encoded by a key unique to each operator, thereby realizing security.

Furthermore, the program described above may be provided in a state in which the program is stored in a recording medium or the program may be provided through a communication unit. In this case, the program described above may be regarded as the invention of a ‘computer-readable recording medium in which a program is recorded’, for example.

The ‘computer-readable recording medium in which a program is recorded’ refers to a recording medium that can be read by a computer recorded with a program, which is used for installation, execution, distribution, and so on of the program.

For example, recording mediums include: in association with a digital versatile disk (DVD), ‘DVD-R, DVD-RW, DVD-RAM, and the like’ that are standards established by a DVD forum and ‘DVD+R, DVD+RW, and the like’ that are standards established by a DVD+RW forum; in association with a compact disk (CD), a read only memory (CD-ROM), a CD recordable (CD-R), and a CD rewritable (CD-RW), and the like; a magneto-optic disk (MO); a flexible disk (FD); a magnetic tape; a hard disk; a read only memory (ROM); an electrically erasable and programmable read only memory (EEPROM); a flash memory; and a random access memory (RAM).

In addition, the program or a part of the program may be stored or distributed in a state in which the program or a part of the program is recorded in the recording medium. Furthermore, the program may be transmitted through communication, for example, a wireline network such as a local area network (LAN), a metropolitan area network (MAN), a wide area network (WAN), Internet, an intranet, and an extranet or a wireless communication network. Alternatively, the program may be transmitted through a transmission medium obtained by combination of those described above or may be carried on a carrier.

Moreover, the program described above may be a part of another program or may be recorded on a recording medium together with a separate program. In addition, the program described above may be divided to be recorded in a plurality of recording mediums. In addition, the program described above may be recorded in any kind of format including compression, encryption, and the like as long as the program can be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a division instruction receiver that receives a division processing instruction which instructs division processing to an original object;
a division processor that executes the division processing to the original object according to the division processing instruction received by the division instruction receiver to generate a plurality of divided objects;
a memory that stores the original object before executing the division processing by the division processor;
a restoration instruction receiver that receives a restoration processing instruction which instructs restoration processing of the division processing of a user selected divided object, which is one of the divided objects;
an identification unit that identifies history information of the selected divided object; and
a restoration processor that executes the restoration processing of the selected divided object to restore the selected divided object to the original object, without affecting other of the divided objects, using the history information identified by the identification unit and the original object which is stored in the memory, according to the restoration processing instruction received by the restoration instruction receiver.

2. The information processing system according to claim 1, further comprising:
a display instruction receiver that receives an instruction which instructs to display an editing history of the selected divided object; and
a display controller for controlling the display of the editing history of the selected divided object subject to the instruction received by the display instruction receiver,
wherein the restoring instruction receiver receives the restoration processing instruction to restore the selected divided object to the original object on the basis of the displayed editing history.

3. The information processing system according to claim 1, wherein the original object and the divided objects are documents which are processed using a word processor.

4. The information processing system according to claim 1,
wherein the division processor stores the plurality of divided objects in a document storage region during the division processing,
wherein the original object is stored in a region for storing state before editing before the division processing, and
wherein the restoration processor retrieves the original object from the region for storing state before editing and causes the original object to be stored in the document storage region.

5. A non-transitory computer-readable medium that stores an information processing program, wherein the program causes a computer to operate as an apparatus comprising:
a division instruction receiver that receives a division processing instruction which instructs division processing to an original object;
a division processor that executes the division processing to the original object according to the division processing instruction received by the division instruction receiver to generate a plurality of divided objects;
a memory that stores the original object before executing the division processing by the division processor;
a restoration instruction receiver that receives a restoration processing instruction which instructs restoration processing of the division processing of a user selected divided object, which is one of the divided objects;
an identification unit that identifies history information of the selected divided object; and
a restoration processor that executes the restoration processing of the selected divided object to restore the selected divided object to the original object, without affecting other of the divided objects, using the history information identified by the identification unit and the original object which is stored in the memory, according to the restoration processing instruction received by the restoration instruction receiver.

6. The non-transitory computer-readable medium that stores an information processing program according to claim 5, wherein the information processing program causes the computer to operate as and the apparatus further comprising:
a display instruction receiver that receives an instruction which instructs to display an editing history of the selected divided object; and
a display controller for controlling the display of the editing history of the selected divided object subject to the instruction received by the display instruction receiver;
wherein the restoring instruction receiver receives the restoration processing instruction to restore the selected divided object to the original object on the basis of the displayed editing history.

7. The non-transitory computer-readable medium according to claim 5, wherein the original object and the divided objects are documents which are processed using a word processor.

8. The non-transitory computer-readable medium according to claim 5,
wherein the division processor stores the plurality of divided objects in a document storage region during the division processing,
wherein the original object is stored in a region for storing state before editing before the division processing, and
wherein the restoration processor retrieves the original object from the region for storing state before editing and causes the original object to be stored in the document storage region.
